(19) United States
(12) Patent Application Publication
(10) Pub. No.: US 2019/0044931 A1
(43) Pub. Date: Feb. 7, 2019

(54) METHOD AND SYSTEM TO AUTHENTICATE AND IMPROVE RELIABILITY OF USER-PROVIDED DATA FOR A SOCIAL NETWORK

(71) Applicant: Billie Wai Guit Tong, Calgary (CA)

(72) Inventor: Billie Wai Guit Tong, Calgary (CA)

(21) Appl. No.: 15/665,841

(22) Filed: Aug. 1, 2017

(51) Int. Cl. H04L 29/06; G06K 9/00; G06F 17/30

(52) U.S. Cl. CPC H04L 63/08; H04L 63/12; G06Q 50/01; G06F 17/30011; G06K 2209/01; G06K 9/00442

(57) ABSTRACT

A system and method for authenticating and improving reliability of personal data provided to and stored within a social media network. The social media network server executes instructions to: receive authentication data for a data entry in a social media profile from a computing device of an account holder; identify an authentication data type corresponding to the authentication data; extract data from authentication data based on identified authentication data type; store a set of the extracted data; use a set of the stored data in a targeted pairing algorithm; retrieve predetermined authentication characteristics; examine the authentication data for an existence of each of the predetermined authentication characteristics; reconcile the authentication data with the associated data entry; determine an authentication outcome based at least in part on the reconciliation of authentication data with the associated data entry and examination of the authentication data for an existence of each of the at least one predetermined authentication characteristics; store an authentication indicator associated with the data entry.

### FIELD OF THE INVENTION

This invention is in the field of social media networking stored and executed on a computing structure, and more specifically for authenticating and improving reliability of personal data provided to and stored within the social media network.

### BACKGROUND

Social networking has grown rapidly over the past decades, with the largest social network having more than 1.8 billion monthly active users. Social networks pair social network users with people, products, and services using algorithms and models. Increasing the reliability of those algorithms and models, may improve the quality of pairings, which in turn benefits users and social networks.

Social media networks, such as Facebook, LinkedIn, MySpace, Twitter, etc., enable people to share user-generated content with a plurality of other users that have been organized into groups. Each user may generate a profile that contains profile data provided by the user. The user may choose to share all, none, or a portion of the profile with other users and/or groups. The user may share, create, discuss, and/or modify the user-generated content or may modify content provided by other users. Social media networks may be accessed using mobile phones, tablets, and/or any other computing device.

### SUMMARY

As disclosed herein, there is provided a social media network system that may comprise a server having at least one server processor, at least one memory, and a transceiver for communicating over a network. The at least one server processor executes computer-readable instructions from at least one memory. Authentication data may be received for a data entry in a social media profile via the transceiver from a computing device of an account holder. An authentication data type corresponding to the authentication data may be identified. Data may be extracted from authentication data based on identified authentication data type. A set of the extracted data may be stored. A set of the stored data may be used in a targeted pairing algorithm. At least one predetermined authentication characteristic may be retrieved. The authentication data may be examined for an existence of each of the at least one predetermined authentication characteristics. The authentication data may be reconciled with the associated data entry. An authentication outcome may be determined based at least in part on the reconciliation of authentication data with the associated data entry and examination of the authentication data for an existence of each of the at least one predetermined authentication characteristics. An authentication indicator may be stored in the at least one memory associated with the data entry.

In a further aspect, there is provided computer-readable instructions to: transmit an authentication indication via the transceiver to another computing device of another account holder; wherein the authentication indication signals the another account holder that the data entry has been authenticated.

The data entry may be selected from: work data, professional skill data, education data, and/or personal data. In some aspects, the authentication data may comprise an image and optical character recognition may be performed on the image. When the data entry is work data, a letter of employment may be accepted. When the data entry is education data, at least one of an official transcript, an unofficial transcript, and a degree may be accepted. When the data entry is personal data, at least one of an driver's license, an citizenship card, an birth certificate, an marriage certificate, an medical report, and an international passport may be accepted. In some aspects, at least one of a university, a student name, a degree type, a GPA, and a plurality of classes with associated grades may be identified.

The authentication data type may be received from the computing device of the account holder.

In yet another aspect, there is provided a method executing on a server for authenticating a data entry in a social media profile of an account holder. The method may comprise receiving authentication data for the data entry in the social media profile from a computing device of the account holder; identifying an authentication data type corresponding to the authentication data; retrieving at least one predetermined authentication characteristic; examining the authentication data for an existence of each of the at least one predetermined authentication characteristics; reconciling the authentication data with the associated data entry; determining an authentication outcome based at least in part on the reconciliation of authentication data with the associated data entry and examination of the authentication data for an existence of each of the at least one predetermined authentication characteristics; and storing an authentication indicator associated with the data entry.

In some aspects, an authentication indication may be transmitted to another computing device of another account holder. The authentication indication may signal the another account holder that the data entry has been authenticated. The data entry may be selected from: work data, professional skill data, education data, and/or personal data. The authentication data type may be received from the computing device of the account holder. The authentication data may comprise an image and optical character recognition may be performed on the image.

When the data entry is work data, a letter of employment may be accepted. When the data entry is education data, at least one of an official transcript, an unofficial transcript, and a degree may be accepted. When the data entry is personal data, at least one of an driver's license, an citizenship card, an birth certificate, an marriage certificate, an medical report, and an international passport may be accepted.

In some aspects, the method may identify at least one of a university, a student name, a degree type, a GPA, and a plurality of classes with associated grades.

Further adaptations and combinations of the aspects described herein may be apparent to one of skill in the art.

### DESCRIPTION OF THE DRAWINGS

While the invention is claimed in the concluding portions hereof, example embodiments are provided in the accompanying detailed description which may be best understood in conjunction with the accompanying diagrams where like parts in each of the several diagrams are labeled with like numbers, and where:

FIG. 1 is a sketch of a user interface for a social media application executing on a computing device;

FIG. 2 is a sketch of another user interface for the social media application executing on the computing device;

FIG. 3 is a conceptual diagram of a computing structure for executing a social media network;

FIG. 4 is a flowchart demonstrating data authentication of user-provided social media data; and

FIG. 5 is a flowchart demonstrated data authentication of user-provided social media for a targeted pairing algorithm and/or model.

### DETAILED DESCRIPTION OF THE ILLUSTRATED EMBODIMENTS

One problem associated with social media networks comprises the trustworthiness of the user-provided content and/or the profile data. Frequently, the social media network provider has implemented their social media platform to encourage providing authentic information from the users. However, the social media platform may only conduct a cursory check of the user-provided content and/or the profile data. This cursory check has caused problems with “fake news” and has prompted the desire for increased accuracy and independent authentication or verification of user-provided content and/or the profile data associated with particular users.

Some methods to authenticate claims include: (1) cross-referencing public information, (2) utilizing the social network as reference sources, and (3) obtaining private information through the enrolment process. Cross-referencing public information may be problematic when there are users that provide consistent but false information across various public domains. The authentication procedure would think that false information is true because of the consistency across public sources. Utilizing the social network faces a similar problem because a set of people could falsify their claims and reference each other, and the procedure would think that the claims are true. Lastly, obtaining information through the enrollment process is a channel that enables social networks to obtain basic information such as a phone number and driver's license. However, if a social network mandates that members provide international passports, letter of employment, official transcripts, degrees, medical reports, and/or other documents in order to enroll, then the enrollment process becomes cumbersome and many users may choose other social networks.

One solution uses an independent authentication service to authenticate information. These authentication services are costly by relying on a person to authenticate the information, which may still be prone to errors. To insure accuracy, these authentication services typically require multiple verifiers to confirm the user-provided content and/or profile data, which may be costly. Other solutions use aggregate quantitative measures, which has a number of shortfalls. For example, users may not understand how the measures are generated, poor quality information may be masked by large volumes of high quality information, obtaining measures sometimes costs users money (e.g. request and paying for a report), require credit checks, and/or additional inconvenience.

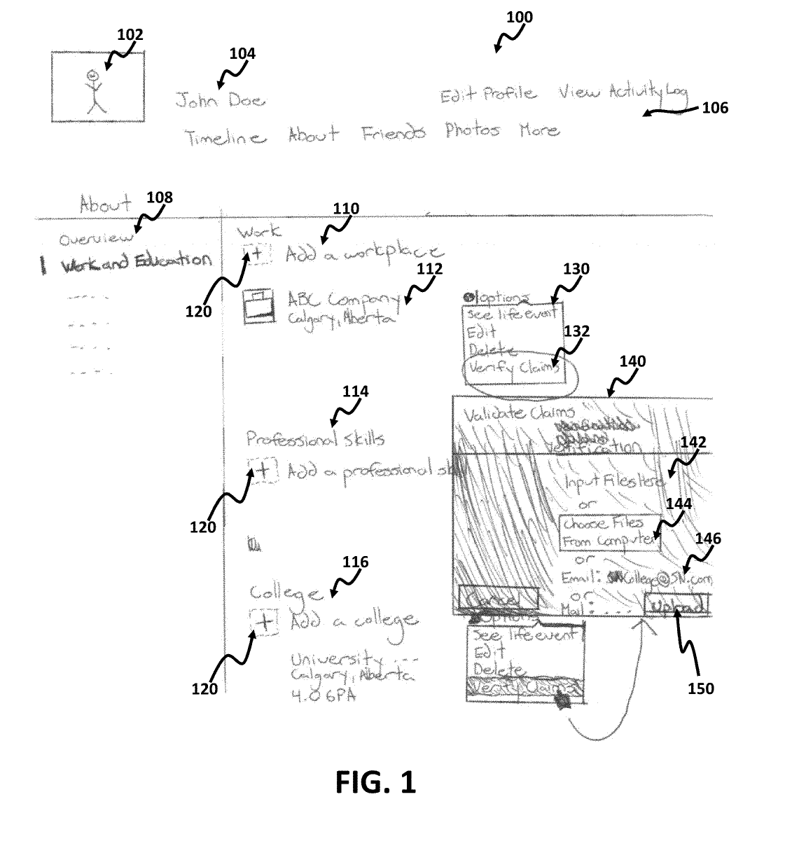

With reference to FIG. 1, there is provided a user interface 100 to be displayed on a computing device 302 for a social media network 300 corresponding to an social network account holder (AH) of a social media profile. The user interface 100 may comprise a profile picture 102 and a profile name 104. A toolbar 106 may be present at a top of the user interface 100 that enables the AH to navigate various information displays, such as a timeline, an “About” where profile data may be presented, a friend view, a photo view, and/or more views. The toolbar 106 may also comprise an Edit Profile option, and/or a View Activity Log.

As shown in FIG. 1, the current view is an “About” where profile data may be presented. In this aspect, a left hand column 108 provides a summary of various categories associated with the profile data, such as work and education. In a right hand column 110, there is provided work data 112, professional skill data 114, and/or education data 116. The AH may add any type of data in the right hand column 110 using a plurality of user interface buttons. For each previously provided individual entry in work data 112, professional skill data 114, and/or education data 116, the AH may right click (or in a touch system, use a “long press” or other gesture) on the individual entry. The right click action may cause a context menu 130 to be displayed containing a plurality of menu items to view further details, edit the individual entry, delete the individual entry, and/or authenticating claims 132. In some aspects, instead of the right click action, an additional “options” button may be presented to access the context menu 130.

When authenticating claims 132 is selected (e.g. left click, touch, etc.), a dialog 140 may be displayed. The dialog 140 may comprise a drag-and-drop area 142 for receiving one or more icons associated with files stored on the computing device 302 for uploading evidence data necessary to authenticate the claims 132. When the icon has been dragged into the drag-and-drop area 142, a file location associated with the icon may be accessed and the file location may be added to an upload queue for uploading the file to a server 304 of the social media network 300. The dialog 140 may also comprise a button 144 that may open a navigation dialog for selecting files stored on the computing device 302 for adding to the upload queue. Once one or more files have been added to the upload queue, an upload button 150 may be pressed to initiate the upload from the computing device 302 to the server 304 of the social media network 300. In yet another aspect, the dialog 140 may present a unique email address associated with the dialog 140 for receiving files emailed to the unique email address. An email system 308 may then upload the files to the server 304 of the social media network 300 over the Internet 306.

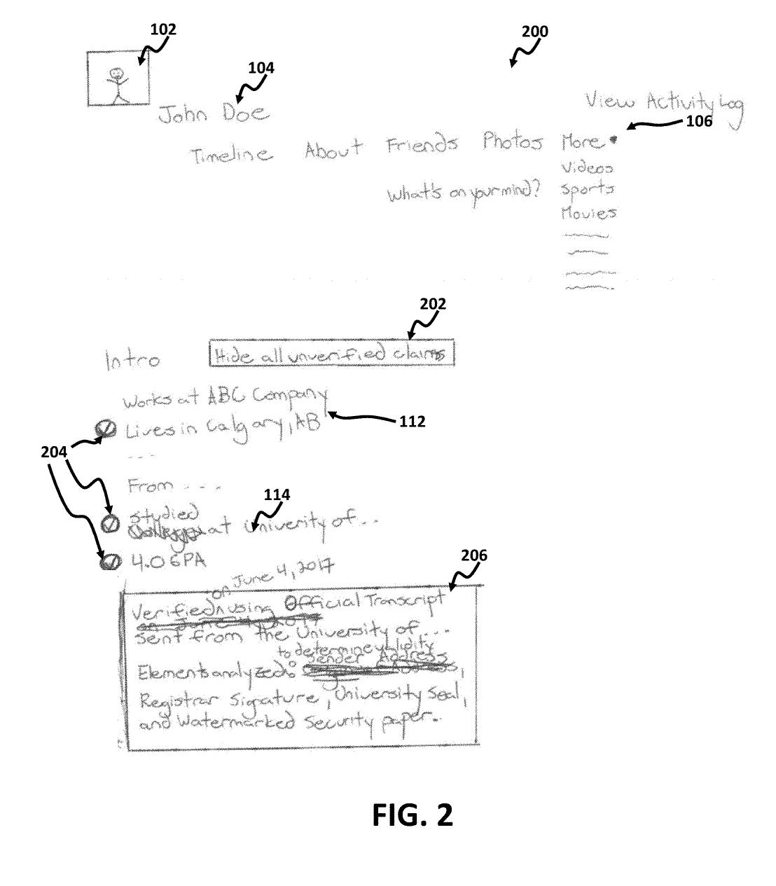

Turning to FIG. 2, there is provided a user interface 200 to be displayed on the computing device 302 for the social media network 300 corresponding to an viewer of the social media profile. The user interface 200 may comprise the profile picture 102 and the profile name 104. The similar toolbar 106 may be present at a top of the user interface 200 that enables the user to navigate various information displays, such as a timeline, an “About” where profile data may be presented, a friend view, a photo view, and/or more views, such as videos, sports, movies, and/or other interests. The toolbar 106 may also comprise an Edit Profile option, and/or a View Activity Log.

There is also provided a plurality of entries corresponding to work data 112, professional skill data 114, and/or education data 116 for the profile data. Beside each of the plurality of entries may be an authentication icon 204 that may indicate that the corresponding entry has been authenticated. When the viewer selects one of the authentication icons 204, the user interface 200 may present a corresponding authentication data entry in an information window 206. For the example presented in FIG. 2, the viewer selected the authentication icon 204 associated with the education data 116 for the profile data. This action caused the server 304 of the social media network 300 to provide the computing device 302 with information regarding the GPA information associated with the education data 116 entry. In this aspect, the authentication data entry lists that the GPA information was verified using an official transcript from a university.

The user interface 200 may comprise a hide button 202 that, when selected by the viewer, may hide all unauthenticated profile data from being displayed within the user interface 200.

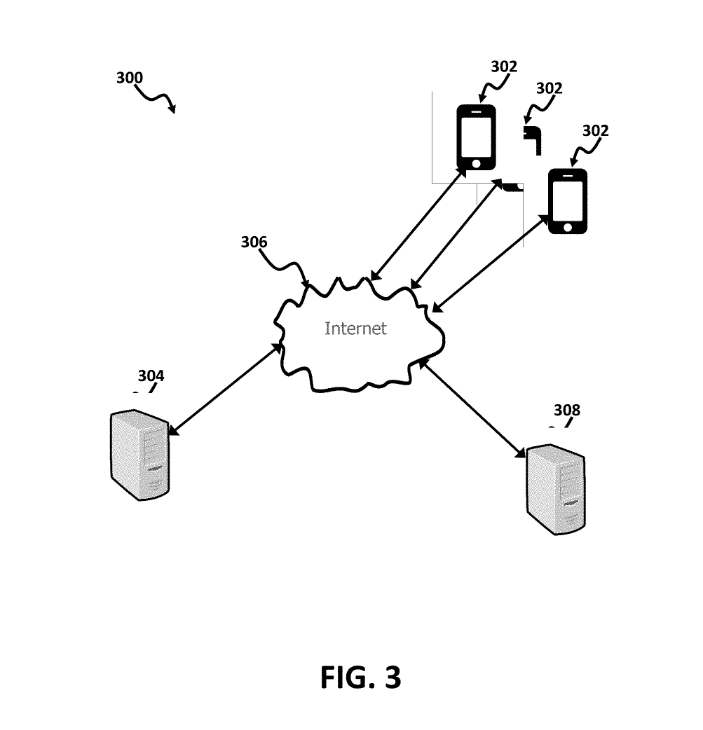

Turning to FIG. 3, there is provided a computing structure 300, also referred to herein as the social media network 300. The computing structure 300 comprises computing devices 302, each having at least one processor, at least one memory, at least one display and at least one transceiver for communication over the Internet 306. For each computing device 302, the processor may read and execute instructions stored within the computer-readable memory to display user interface 100 and/or user interface 200. Each computing device 302 may also comprise instructions stored within the memory for retrieving profile data, user-provided data, and/or authentication data from the server 304. Similarly, each computing device 302 may comprise instructions stored within the memory for transmitting (e.g. uploading) modified profile data, user-provided data, and/or authentication data to the server 304.

The computing structure 300 may also comprise at least one server 304, each having at least one server processor, at least one server memory, and at least one server transceiver for communication over the Internet 306. For each server 304, the server processor may read and execute instructions stored within the server memory to transmit and/or receive profile data, user-provided data, and/or authentication data from the computing devices 302 over the Internet 306. In some aspects, the computing structure 300 may comprise the email system 308 capable of receiving and transmitting email messages. In some aspects, the email system 308 may reside within the server 304.

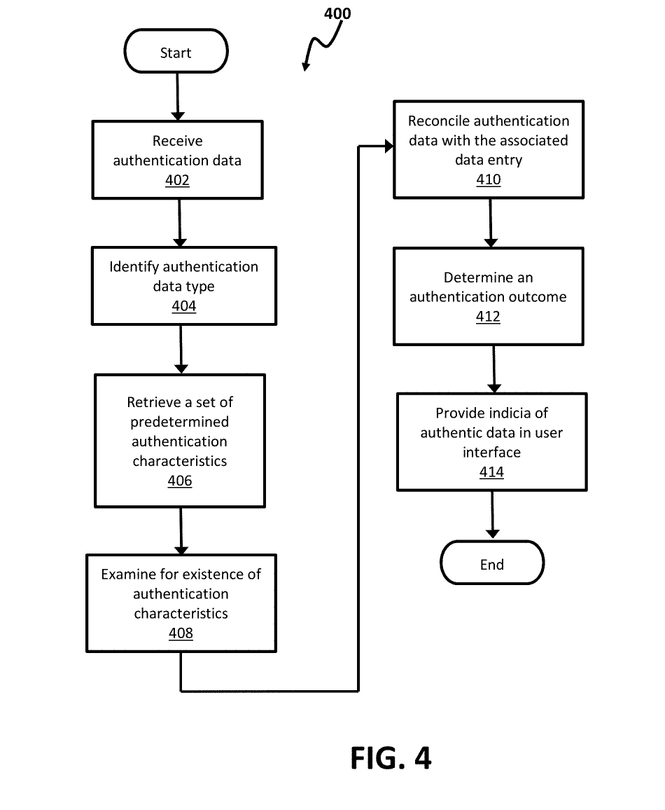

FIG. 4 presents an example flowchart for a profile data authentication process 400 executing on one of the servers 304. The data authentication process 400 begins by receiving authentication data associated with one of the data entries in work data 112, professional skill data 114, and/or education data 116 over a network 306 from one of the computing devices 302 at step 402. A authentication data type may be identified at step 404. The authentication data type may be identified based on the selected “verify claim” option. For example, when the authenticate claims button 132 is selected for a work entry, accepted authentication data types may be letters of employment. In another example, when the authenticate claims button 132 is selected for an education entry, accepted authentication data types may be official transcripts, unofficial transcripts, and/or degrees. A set of drop down lists may be present in dialog 140 that the AH may select the authentication data type. For example, a drop down list may enable the AH to select official transcript, unofficial transcript, or degree, and another list may enable the AH to select from a set of universities. In some aspects, an “other” option may permit the AH to upload any non-standard document type that other users may be able to view in order to authenticate the user profile and/or user-provided data.

For example, an image of an official university transcript may identify a particular university, may comprise a student name, a degree type, a GPA, a plurality of classes and associated grades. In other examples, letters of employment, publications, and/or distinguished awards for authentication. In another example, an image of a driver's license may identify the state, province, or territory, driver's license number, photograph, etc. Moreover, the authentication data type may also comprise security features that assist in authentication of the entry. In some aspects, the data authentication process 400 may comprise identifying a standardized authentication data type (e.g. official university transcript) from a non-standardized authentication data type (e.g. letter of reference).

Based on the authentication data type, an acceptable identification template comprising a plurality of authentication characteristics may be retrieved from a preexisting database of acceptable identification templates at step 406. For example, a preexisting image of an acceptable official university transcript associated with the particular university may be retrieved from the database comprising of authentication characteristics such as a registrar signature, a university seal, and a watermarked security paper. In another example, a preexisting image of an acceptable driver's license template associated with that state may be retrieved from the database comprising of authentication characteristics such as document layout, formatting of data located in different regions, and colour structure. Authentication characteristics may also be obtained from authentic versions of the authentication data, AH's social media network profile (e.g. Name of AH), issuer, entity that governs, and/or other entities knowledgeable of authentication characteristics associated with the authentication data, and stored, which may be later retrieved at step 406. In an aspect, optical character recognition (OCR) may convert the authentication data from image data to text data and the process may determine if the text is located at the correct position. Other aspects may determine if the font size, font format, name, and/or expiration date match the authentication characteristics. At step 408, the authentication data may be examined for an existence of each authentication characteristic.

The authentication data associated with an entry may be reconciled with the entry at step 410. In some aspects, the authentication data associated with an entry may be transformed before reconciling with the entry at step 410. For example, a letter grade may be transformed into a Grade Point Average (GPA). In other aspects, authentication data may be used to populate a set of data entries. For example, a school data entry field may be left blank, entered inconsistently with data found in authentication data, or entered consistently with data found in authentication data, and may be populated using data found in an official transcript. In other aspects, an AH may be provided an interface that enables selection of data entries that may be populated given the authentication data provided. At step 412, the authentication data may be determined to be authentic or not based at least in part on step 408 and step 410. If the profile data and/or user-provided data has been determined to be authentic at step 412, then the authentication icon 204 may be provided in the user interface indicating authentic data at step 414. In other aspects, the server processor may store an indicator in memory that the user-provided data has been authenticated.

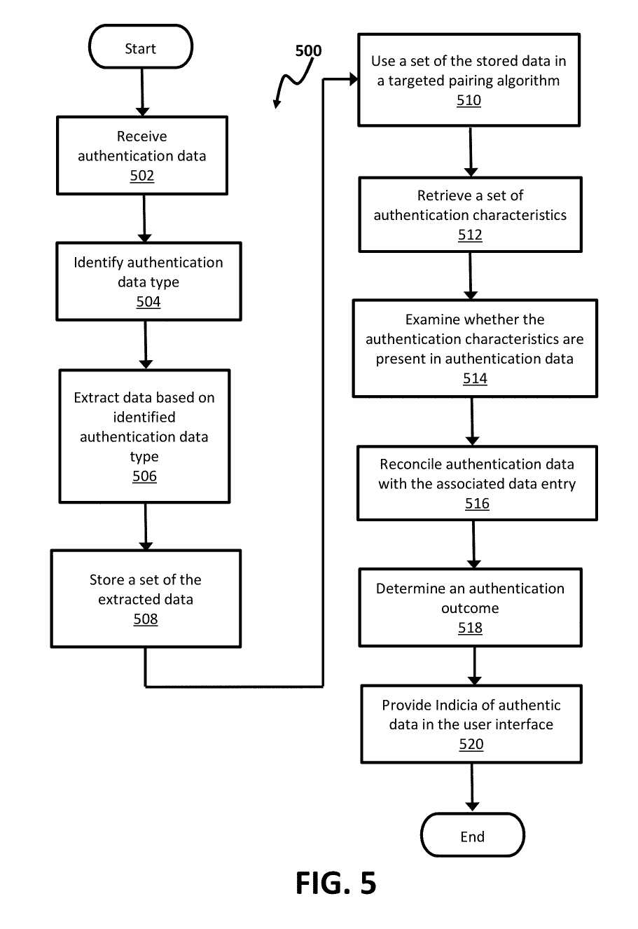

Turning now to FIG. 5, a process 500 for increasing reliability of pairing algorithms is provided. The process begins by receiving authentication data (step 502); identifying the authentication data type (step 504); and extracting data based on the identified authentication data type (step 506). For example, extracted data may comprise, from a driver's license, date of birth, address, height, weight, eye colour, etc. The extracted data may be extracted by specifying a region in which specific information should be located and using OCR. For authentication data types where a designated process to extract specific information from the authentication data is not specified (e.g. AHs selecting “other” from a drop down list, or data types like letter of employment where the location of specific information may not be standardized), the method may not identify the extracted data with a specific data type (e.g. extracting an email address but not identifying it as an email address in a database). The process 500 continues by storing a set of the extracted data in memory (step 508). The targeted pairing algorithm and/or model may then use a set of the stored data to select targeted promotions (step 510). As previously described with reference to FIG. 4, the process 500 may then retrieve a set of predetermined authentication characteristics (step 512); examine whether the authentication characteristics are present in the authentication data (step 514); reconcile authentication data with the associated data entry (step 516); determine whether the authentication data is authentic based at least in part on step 514 and step 516 (step 518); and if the authentication data is determined to be authentic, provide an indicia (e.g. authentication icon) of the authentic data in the user interface (step 520).

In some aspects, the social media network 300 may collect a plurality of authentication characteristics from authentication data that has been previously provided by users of the social media network 300. For example, if many users have uploaded an official transcript from a particular university, each of these official transcripts may be compared to each other in order to identify common features therebetween. The common features may then form part of the acceptable identification template or authentication characteristics.

In some aspects, a government authority, licensing agency, regulatory organization, and/or professional association may provide acceptable identification templates over the Internet to the server 304. In some aspects, the authentication data associated with the entry may be compared to the acceptable identification template on an authoritative server (e.g. the server is associated with the government authority, etc.).

In other aspects, the acceptable identification templates may be formed from a Google Image search in order to locate a previously acceptable identification template.

Through providing an improved authentication of the data provided to the social network, there may be a benefit to the sources of revenue for the social network provider. Revenue for a social network provider are primarily derived from sponsored promotions, membership fees, and gifting.

For sponsored promotions, the success is dependent on the algorithms and models used to pair users with appropriate products, services, and/or people. Increasing reliability of those algorithms and models should increase a number of promotions clicked and promotion-related products and services purchased. The targeted pairing algorithms becomes more reliable as input quality improves.

For membership fees and/or gifting, these may be dependent on user's overall experience on the social network. Better experience generally translates to higher revenue generated by membership fees and/or gifting services. Authenticity of claims is one of the most prominent complaints of social networks (particularly for dating social networks). Many people are reluctant to use dating social networks because they are worried about being deceived. Through authentication of claims, users may have increased confidence in the other users.

According to one aspect, the authentication data may be used for differentiation of one user from another user. For example, LinkedIn has ˜500 million users in 2017, suppose 5% of LinkedIn users authenticate at least a portion of their profile and/or user-provided data. This means ˜25 million users have an advantage in networking with Hiring Managers and Recruiters. This may provide sufficient incentive for other users to also have their profile data and/or user-provided data verified. In addition, recruiters and hiring managers may apply filters during candidate searches to remove unverified data.

In another aspect, Tinder has ˜50 million users in 2017, suppose 5% of Tinder users authenticate at least a portion of their profile and/or user-provided data. This means 2.5 million users have an advantage over other users. For example, a person looking for a date may be embarrassed by selecting to date someone with unverified data, e.g. employment is listed as a Hedge Fund Manager when really the person is a teenager playing a prank. This may also provide sufficient incentive for other users to also have their profile data and/or user-provided data verified.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention. Each aspect presented herein may be used in any and all combinations.

What is claimed is:

1. A social media network system comprising a server having at least one server processor, at least one memory, and a transceiver for communicating over a network; the at least one server processor executing computer-readable instructions from at least one memory to:
receive authentication data for a data entry in a social media profile via the transceiver from a computing device of an account holder;
identify an authentication data type corresponding to the authentication data;
extract data from authentication data based on identified authentication data type;
store a set of the extracted data;
use a set of the stored data in a targeted pairing algorithm;
retrieve at least one predetermined authentication characteristic;
examine the authentication data for an existence of each of the at least one predetermined authentication characteristics;
reconcile the authentication data with the associated data entry;
determine an authentication outcome based at least in part on the reconciliation of authentication data with the associated data entry and examination of the authentication data for an existence of each of the at least one predetermined authentication characteristics; and
store an authentication indicator in the at least one memory associated with the data entry.

2. The social media network system according to claim 1, further comprising computer-readable instructions to: transmit an authentication indication via the transceiver to another computing device of another account holder; wherein the authentication indication signals the another account holder that the data entry has been authenticated.

3. The social media network system according to claim 1, wherein the data entry is selected from: work data, professional skill data, education data, and/or personal data.

4. The social media network system according to claim 1, further comprising computer-readable instructions to: receive the authentication data type from the computing device of the account holder.

5. The social media network system according to claim 3, wherein the authentication data comprises an image.

6. The social media network system according to claim 5, further comprising computer-readable instructions to: perform optical character recognition on the image.

7. The social media network system according to claim 6, further comprising computer-readable instructions to: accept a letter of employment when the data entry is work data.

8. The social media network system according to claim 6, further comprising computer-readable instructions to: accept at least one of an official transcript, an unofficial transcript, and a degree when the data entry is education data.

9. The social media network system according to claim 6, further comprising computer-readable instructions to: accept at least one of an driver's license, an citizenship card, an birth certificate, an marriage certificate, an medical report, and an international passport when the data entry is personal data.

10. The social media network system according to claim 8, further comprising computer-readable instructions to: identify at least one of a university, a student name, a degree type, a GPA, and a plurality of classes with associated grades.

11. A method executing on a server for authenticating a data entry in a social media profile of an account holder comprises:
receiving authentication data for the data entry in the social media profile from a computing device of the account holder;
identifying an authentication data type corresponding to the authentication data;
retrieving at least one predetermined authentication characteristic;
examining the authentication data for an existence of each of the at least one predetermined authentication characteristics;
reconciling the authentication data with the associated data entry;
determining an authentication outcome based at least in part on the reconciliation of authentication data with the associated data entry and examination of the authentication data for an existence of each of the at least one predetermined authentication characteristics; and
storing an authentication indicator associated with the data entry.

12. The method according to claim 11 further comprises: transmitting an authentication indication to another computing device of another account holder; wherein the authentication indication signals the another account holder that the data entry has been authenticated.

13. The method according to claim 11, wherein the data entry is selected from: work data, professional skill data, education data, and/or personal data.

14. The method according to claim 11 further comprises: receiving the authentication data type from the computing device of the account holder.

15. The method according to claim 13, wherein the authentication data comprises an image.

16. The method according to claim 15, further comprises: performing optical character recognition on the image.

17. The method according to claim 16, further comprises: accepting a letter of employment when the data entry is work data.

18. The method according to claim 16, further comprises: accepting at least one of an official transcript, an unofficial transcript, and a degree when the data entry is education data.

19. The social media network system according to claim 16, further comprising computer-readable instructions to: accept at least one of an driver's license, an citizenship card, an birth certificate, an marriage certificate, an medical report, and an international passport when the data entry is personal data.

20. The method according to claim 18, further comprises: identifying at least one of a university, a student name, a degree type, a GPA, and a plurality of classes with associated grades.
